(19) United States
(12) Patent Application Publication
(10) Pub. No.: US 2022/0312701 A1
(43) Pub. Date: Oct. 6, 2022

(54) SHELVING FOR SOILLESS CULTIVATION, UNIT PARTICULARLY INTENDED TO BE INCLUDED IN SUCH SHELVING, SOILLESS CULTIVATION MODULE COMPRISING SUCH A UNIT, AND SOILLESS CULTIVATION SYSTEM COMPRISING AT LEAST TWO OF SUCH SHELVING

(71) Applicant: SMART FARMING SYSTEM, Paris (FR)

(72) Inventors: Cyril Veran, Paris (FR); Thomas Dalbarade, Paris (FR)

(73) Assignee: SMART FARMING SYSTEM, Paris (FR)

(21) Appl. No.: 17/615,138

(22) PCT Filed: Jun. 2, 2020
(86) PCT No.: PCT/EP2020/065247

§ 371 Date: Nov. 30, 2021

(30) Foreign Application Priority Data
Jun. 4, 2019 (FR) FR1905923

(51) Int. Cl. A01G 31/06

(52) U.S. Cl. CPC A01G 31/06

(57) ABSTRACT

Shelving (200) for soilless cultivation, comprising at least one first row (201) and one second row (201), each row (201) comprising at least one cultivation unit (300), each cultivation unit (300) comprising at least one cultivation compartment (307), the shelving further comprising a device (202) for moving the two rows (201) with respect to one another in such a way that the shelving (200) can adopt two configurations: —an open configuration in which the growing media (308) are accessible from an aisle (203) between the two rows (201); —a closed configuration in which the cultivation compartments (307) form at least one cultivation chamber (204), the shelving (200) further comprising a sealing system (205) that limits the exchanges of air between the cultivation chamber (204) of the shelving (200) in the closed integration and the outside.

### FIELD OF THE INVENTION

The present invention relates to the field of soil-less cultivation, which includes hydroponics and aeroponics.

### TECHNOLOGICAL BACKGROUND

More specifically, the invention relates to a soil-less cultivation system.

Soil-less cultivation, unlike traditional cultivation, consists mainly in doing without soil, in order to provide the plants directly and solely with the nutrients, also called inputs, that they need, with greater control than in traditional cultivation. The advantages of soil-less cultivation are numerous. In particular, yields are increased and the risk of disease is reduced. This also limits the use of treatments to cure or prevent disease.

The domain of soil-less cultivation includes, but is not limited to, hydroponics and aeroponics.

Hydroponics is the use of an inert substrate in which the roots of the plants develop, and the irrigation of the substrate with a nutrient solution including the inputs. Aeroponics does not require a substrate, and the roots of the plants develop in the air. The inputs are then sprayed onto the roots, for example.

In aeroponics, a further distinction is made between low-pressure and high-pressure aeroponics.

Low-pressure aeroponics systems are the most common systems used today. They are characterised by the fact that the nutrient solution is sprayed through sprinklers by a water pump, which usually has a high flow rate but delivers a low pressure. They correspond to an evolution of hydroponic systems where the irrigation system has been replaced.

In high-pressure aeroponics systems, it is no longer a question of using simple sprinklers but nozzles.

The development of a plant as well as its productivity remain closely linked to the proportion of water/nutrients and oxygen available at the root level. Indeed, a large proportion of the oxygen taken up is in the root system.

High pressure uses nozzles to mist the nutrient solution onto the root system. This mist is composed of droplets, for example with a size of about fifty microns. This figure is known to be close to the size of the pores on plant roots. In this way, the assimilation capacity of the plants is maximised and the exchange between the roots and the propagation medium is optimised.

Soil-less cultivation is of particular interest in regions where the climate makes traditional cultivation particularly complicated or impossible due to the lack of cultivable soil and/or extreme temperatures and/or wide climatic variations. Typically, a soil-less cultivation system is installed in a dedicated room, where conditions are improved compared to outside.

However, the installation of soil-less cultivation systems, as for example in US 2014/144,079, requires the installation of all the necessary equipment, such as plant supports, means of supplying inputs and a system for controlling various parameters of the cultivation, such as temperature. Installing all of this equipment therefore requires time and expertise, is costly, and can take up a significant amount of space.

In addition, when different plant species are grown in the same space, special precautions can be needed to separate species that require different conditions, making the cultivation system even more complex and costly.

There is therefore a need to provide a solution to the above-mentioned disadvantages.

### SUMMARY OF THE INVENTION

Thus, according to a first aspect, the invention relates to a soil-less cultivation rack including at least a first row and a second row. Each row includes at least one cultivation unit. Each cultivation unit comprises a frame enclosing at least one cultivation compartment, the frame of each unit having an opening into the cultivation compartment and closed by a bottom on the side opposite the opening. Each cultivation unit is equipped with equipment to allow the soil-less cultivation of at least one plant. Thus, each unit comprises at least one growth medium in the cultivation compartment attached to the frame. The growth medium is intended to allow the attachment and development of at least one plant. The rack includes a nutrient solution delivery system in the cultivation compartment of each unit. The rack also includes a device for moving the two rows relative to each other so that the rack can take on two configurations:

an open configuration, wherein the cultivation compartment of each unit of the first row is separated from the cultivation compartment of each unit in the second row by an open-air circulation corridor, the growth media being accessible from the circulation corridor;

a closed configuration, wherein the opening of each unit of the first row is in communication with the opening of at least one unit of the second row, so that the cultivation compartments are shared and form at least one cultivation chamber, the rack also including a sealing system limiting the exchange of air between the cultivation chamber of the rack in the closed configuration and the outside.

Thus, in the closed configuration of the rack, the cultivation chamber forms an environment that can be easily controlled, separated from the outside environment, favouring the development of the plant. The open configuration gives access to the interior of the units for e.g. carrying out actions on the plants, placing the plants on the growth medium, harvesting the plants.

This makes soil-less cultivation easier, with greater control over the atmosphere in which the plants develop.

The rack can be placed in any location. Since the closed configuration of the rack isolates the plants from the outside environment, the latter does not need to be precisely controlled.

The rack allows as many cultivation chambers as desired to be formed, for example by increasing the number of units and/or cultivation compartments per unit

According to different aspects, it is possible to provide for one and/or other of the following arrangements.

According to one embodiment, the sealing system can include a device for pressurizing the cultivation chamber and/or at least one seal extending around the cultivation chamber, when the rack is in the closed configuration.

According to one embodiment, the two rows are slidably movable relative to each other in a transverse direction, and wherein the frame opening of each unit extends parallel to a longitudinal plane. Preferably, the transverse direction is horizontal, the longitudinal direction is vertical. Thus, the rack units are in a vertical position, limiting the floor space occupied.

According to one embodiment, each row of the rack can comprise at least two cultivation units. The two units are placed adjacent to each other. In practice, the number of units per rack can be any number. The frame of each unit includes two side walls connecting a top wall and a bottom wall. The side walls, the top wall and the bottom wall enclose the cultivation compartment. Two or more units of a same row are joined together by a side wall. The frame opening of both units in the same row is oriented in the same direction so that the cultivation compartment of one row is accessible from the corridor when the rack is in the open configuration. The cultivation compartment of each unit in a first row is then in communication with the cultivation compartment of a unit in the second row when the rack is in the closed position.

According to one embodiment, the rack can include equipment for measuring at least one characteristic of the atmosphere of the cultivation chamber and a system for regulating said characteristic of the atmosphere in the cultivation chamber of the rack in the closed position.

Thus, the control of the atmosphere in the cultivation chamber can be done according to a control set-point, from which the characteristic of the atmosphere can be:

temperature, and/or humidity, and/or light.

According to one embodiment, the rack can have a nutrient solution control system.

According to a second aspect, the invention relates to a soil-less cultivation unit for soil-less plant cultivation particularly intended to be included in a cultivation rack as presented above. The unit includes a frame surrounding at least one cultivation compartment. The frame of each unit has an opening into the cultivation compartment, and each unit has a growth medium in the cultivation compartment attached to the frame.

According to one embodiment, the growth medium includes at least one inert plate defining a so-called root side, in which the roots of the plant are intended to be placed, and a so-called plant side, in which the stems and/or leaves of the plant are intended to be placed. The unit then includes an outlet for the nutrient solution delivery system on the root side.

According to one embodiment, the outlet of the delivery system includes at least one nozzle projecting droplets of the nutrient solution.

According to one embodiment, the growth medium plate extends parallel to the frame opening. The growth medium plate is thus preferably vertical.

According to a third aspect, the invention relates to a soil-less cultivation module which includes at least two cultivation units as presented above, wherein the frame of both units includes a bottom on the side opposite the opening, the bottom of the frames of both units of the module being common.

According to a fourth aspect, the invention relates to a soil-less cultivation system including at least two racks as presented above, the rows of the two racks being placed substantially parallel to each other.

According to one embodiment, the units of a row of a first rack and the units of a row of a second rack are assembled and form a row of modules as shown above.

### BRIEF DESCRIPTION OF THE DRAWINGS

Embodiments of the invention will be described below while referring to the drawings, briefly described below:

FIG. 1 schematically represents a soil-less cultivation system according to an embodiment of the invention, seen from the side, the system including two racks, each rack including two rows of cultivation units, both racks being in the closed configuration.

FIG. 2 shows schematically an example of a cultivation unit of the cultivation system of FIG. 1 seen from the front.

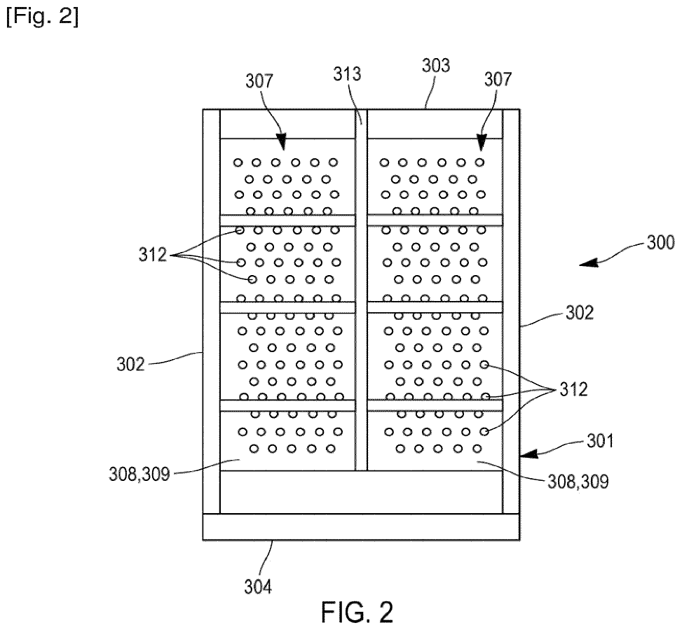

FIG. 3 shows schematically an example of a module including two cultivation units according to FIG. 2 seen in side section.

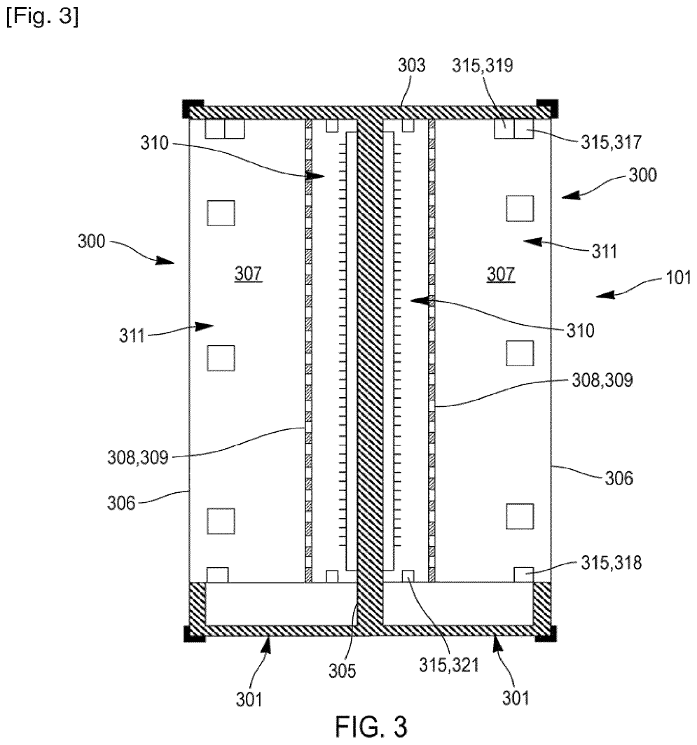

FIG. 4 shows schematically an example of a module including a cultivation unit according to FIG. 2 seen in cross-sectional sideview.

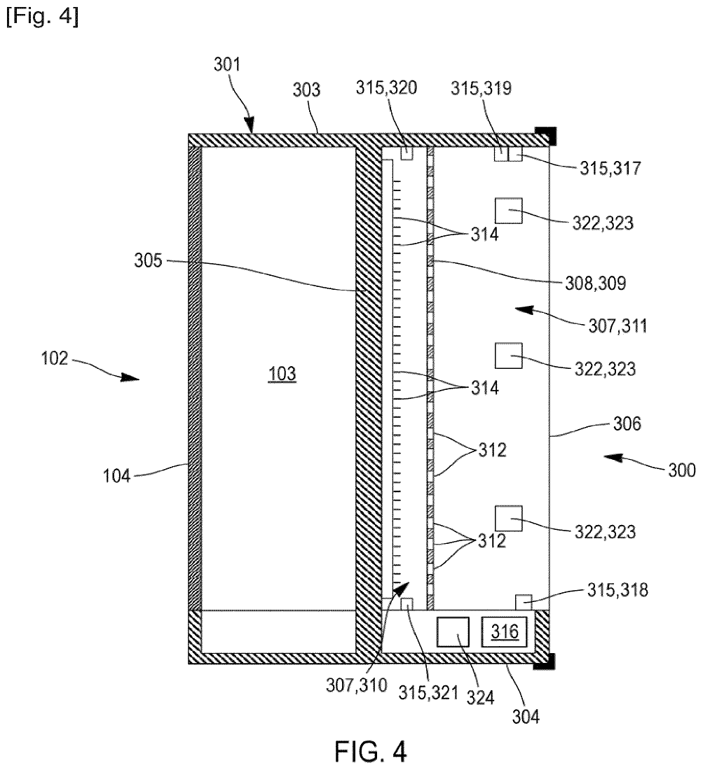

FIG. 5 is a cross-sectional side view of the system in FIG. 1.

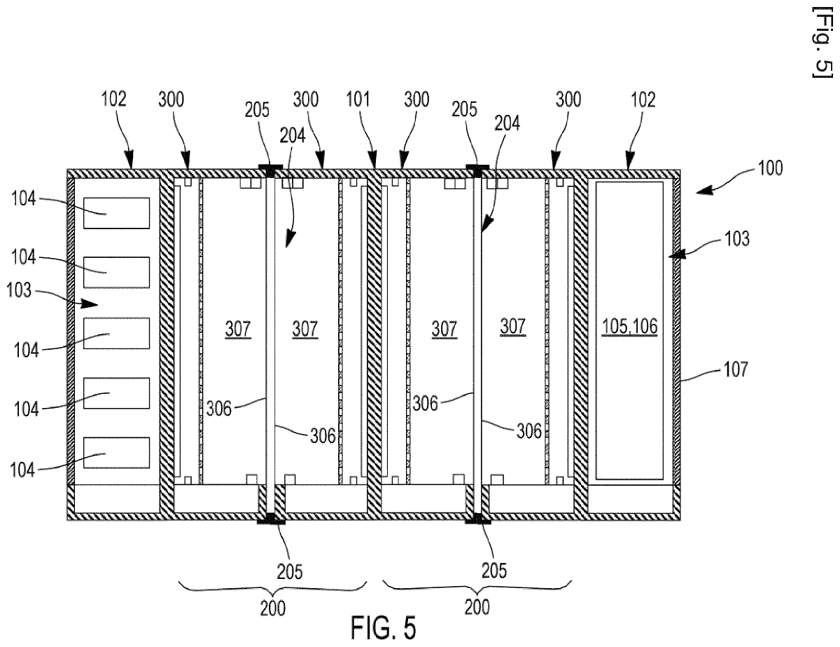

FIG. 6 is a top view of the cultivation system in FIG. 1.

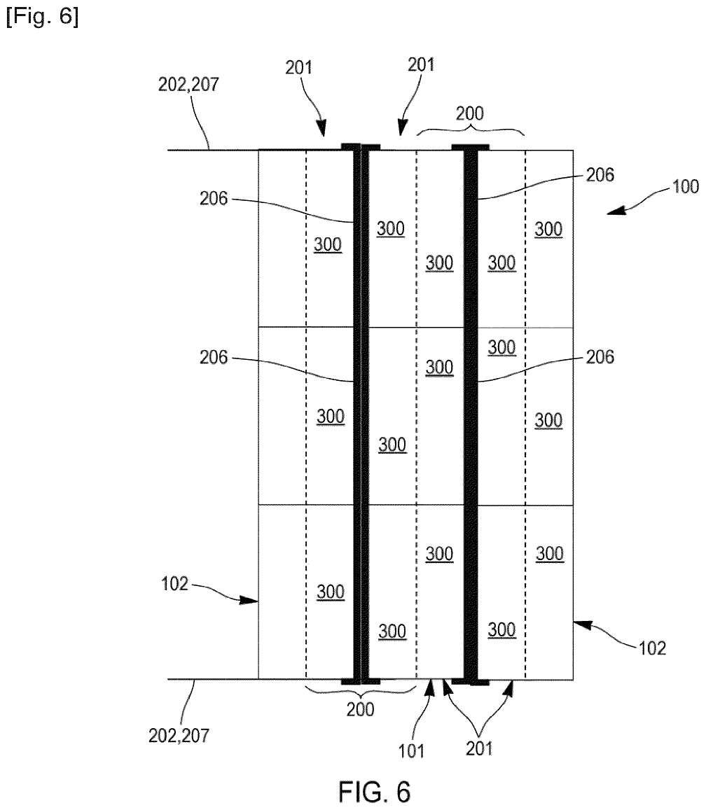

FIG. 7 shows a schematic of the soil-less cultivation system of FIG. 1, seen from the side, with one rack in the open configuration and the other rack in the closed configuration.

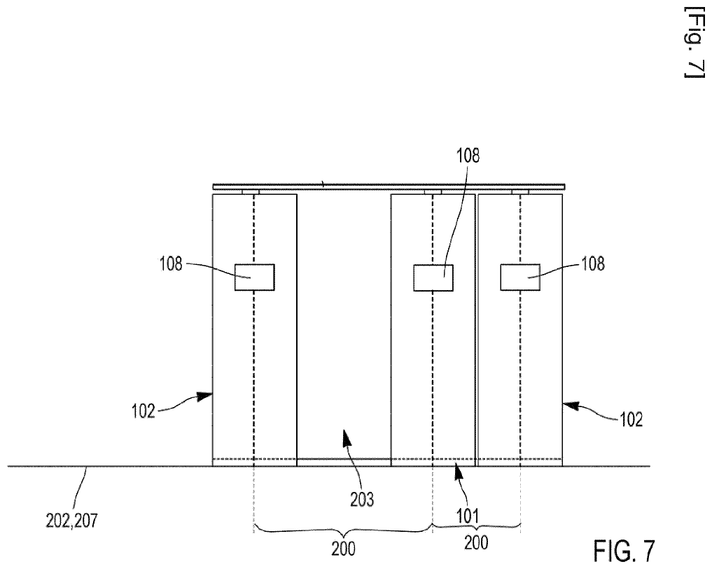

FIG. 8 is a cross-sectional side view of the system in FIG. 7.

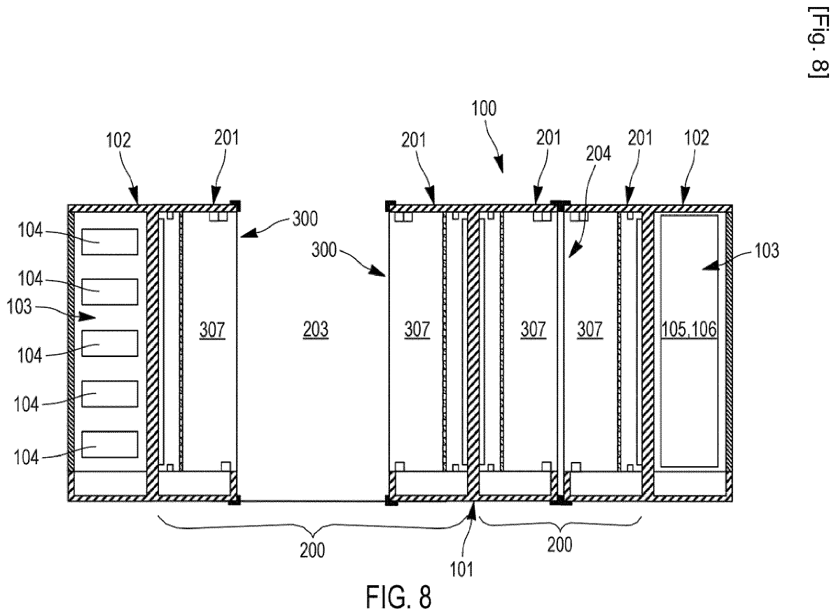

FIG. 9 is a top view of the cultivation system in FIG. 7.

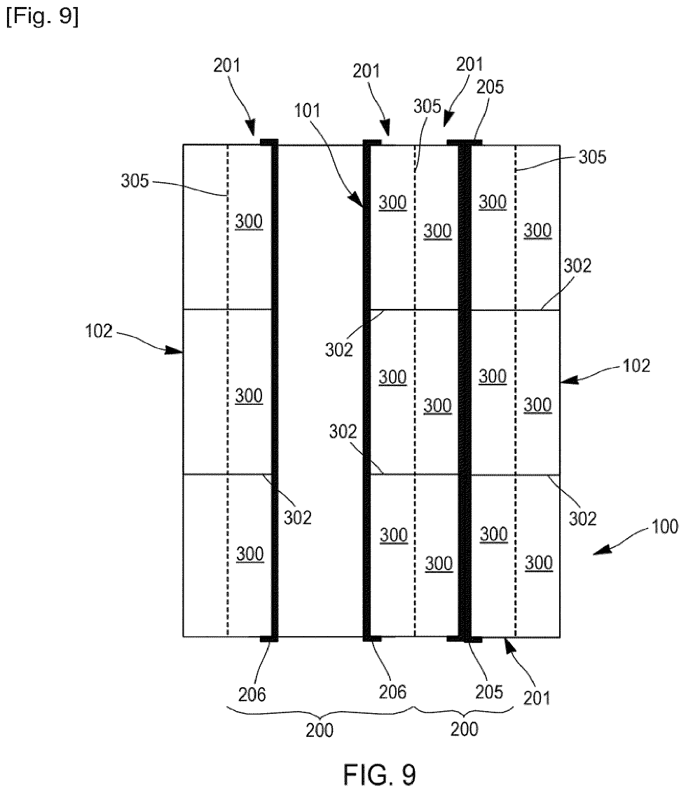

FIG. 10 is a schematic representation of an example of a regulation system and a control system for a nutrient solution.

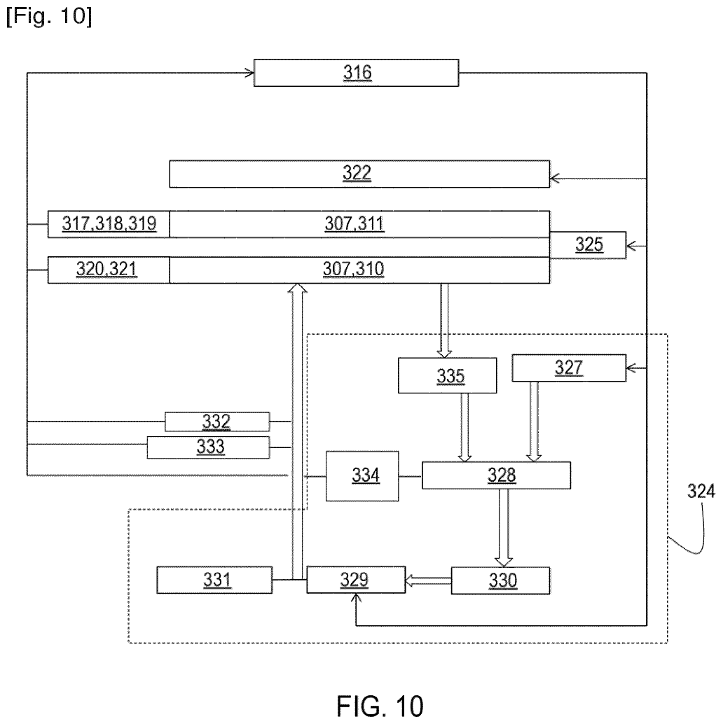

In the drawings, identical numbers refer to identical or similar objects.

### DETAILED DESCRIPTION

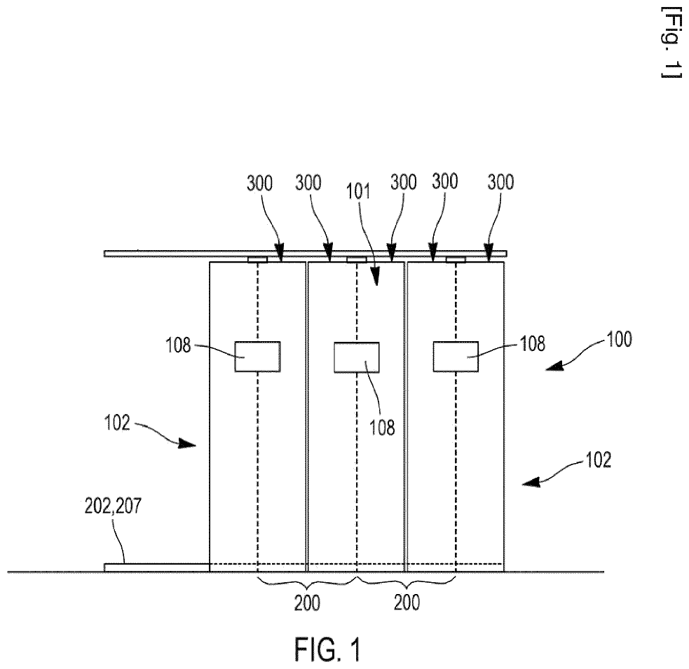

FIG. 1 shows an example of a soil-less cultivation system 100 including two cultivation racks 200. In practice, the system 100 can include more than two racks 200, as will be seen below.

Each rack 200 includes at least two soil-less cultivation units 300, placed face-to-face. In practice, a rack 200 is organised from two rows of units 300. Each row includes at least one, in practice several, cultivation units 300. The cultivation units 300 in one row of a rack face the cultivation units 300 in the other row. Rack 200 will be described further below.

Each cultivation unit 300 includes a frame 301 which comprises two side walls 302 connecting a top wall 303 and a bottom wall 304. The walls 302, 303, 304 of the frame 301 form a frame, generally rectangular in shape according to the example of the figures, closed on one side by a bottom wall 305 and having an opening 306 on the other side.

The opening 306 gives access to at least one cultivation compartment 307 bordered by the walls 302, 303 and 304 of the frame. The opening 306 extends in a longitudinal plane, which is substantially vertical according to the embodiment shown in the figures.

For clarity, the terms horizontal, vertical, upper, lower, top, bottom and variations thereof refer to the natural orientation of the figures, in which, according to the embodiment shown herein, the units 300 are placed in a vertical position with the lower wall 304 in direct or indirect contact with the ground, and the upper wall 303 vertically offset from the lower wall 304, and are not to be understood as limiting.

The cultivation compartment 307 includes equipment to carry out the soil-less cultivation. In particular, it includes at least one growth medium 308 attached to the frame 301, possibly in a detachable manner. The growth medium 308 allows plants to cling and to develop in the presence of nutrients, also called inputs.

According to the embodiment shown here, the unit 300 is particularly intended for aeroponics. For this purpose, the growth medium 308 includes at least one inert plate 309, i.e. it is made of a material which does not interact with the plant. The plate 309 separates in the cultivation compartment 307 a so-called root side 310, i.e. a side in which the roots of a plant attached to the plate 309 are located, and a so-called plant side 311, i.e., the side in which the stem(s) and leaves of a plant attached to the plate 309 are located and develop.

According to the embodiment shown, the plate 309 extends substantially parallel to the frame opening 306, i.e. it extends vertically. The plate 309 then includes a plurality of holes 312, each hole 312 being through-going so that a plant placed in a hole 312 can have its roots on the root side 310 and its stems and/or leaves on the plant side 311. The axis of the holes 312 can be horizontal, i.e. perpendicular to the plane of the plate 309, or it can be inclined with respect to the horizontal direction, downwards on the root side, in order to favour the development of the plant which is naturally vertical.

Preferably, the plate 309 of the growth medium 308 extends vertically over the entire height into the compartment 307. It can also extend across the entire width of the compartment 307. Even more preferably, the plate 309 is opaque, in order to avoid light pollution from the plant side 311 to the root side 310.

Alternatively, the plate 309 can extend horizontally. In this case, several plates 309 can be placed in the cultivation compartment 307 in the manner of rack boards.

In the case of hydroponics, the growth medium 309 can include a container containing a substrate in which the roots of the plants develop.

As illustrated in the figures, each cultivation unit 300 can include two cultivation compartments 307, which can, but do not have to be, identical. For example, the two cultivation compartments 307 can be separated from each other by an intermediate wall 313 of the frame 301, the intermediate wall 313 being parallel to the side walls 302. This allows, for example, different species to be physically separated in each compartment 307, allowing their development to be controlled.

According to the embodiment of the figures, each unit 300 also includes an outlet 314, in practice a plurality of outlets 314, for a nutrient solution delivery system. The outlets 314 are, for example, injection nozzles for spraying nutrient solution on the root side 310 of the cultivation compartment 307. The nutrient solution is typically water and a mixture of inputs, such as nitrogen, potassium, oxygen and potassium, or any other element necessary for the development of the plant. The nozzles are set to spray the nutrient solution as a mist, i.e. as droplets of a size that can be easily absorbed by the roots, as described in the introduction. The nozzles are distributed in such a way that the roots on the root side 310 are all reached by droplets, the mist being formed homogeneously on the root side.

The composition of the nutrient solution can be adapted according to measurements taken in the cultivation compartment 307, indicative of the state of the plant, and/or according to a determined cycle.

A device can be provided to isolate the root side 310 from the plant side 311, to prevent some of the nutrient solution from passing unnecessarily to the plant side 311. A recovery system can be set up on the root side 310 allowing to recover at least part of the solution not absorbed by the roots and to filter it in order to send it back to the roots.

The unit 300 can further include equipment 315 for measuring at least one characteristic of the atmosphere of the cultivation compartment 307 and a system 316 for regulating said characteristic.

Specifically, the measuring equipment 315 can include, but is not limited to:

a temperature sensor 317 on the plant side 311;

a humidity metre 318 on the plant side 311;

a light sensor 319 on the plant side 311.

As will be explained later, the sensors 317, 318, 319 on the plant side 311 can be shared by one or more units 300.

The light sensor 317 can advantageously include a camera for further visualization of the plants on the plant side 311.

The measuring equipment 315 can further include:

a temperature sensor 320 on the root side 310;

a humidity metre 321 on the root side 310;

The regulation system 316 is for example a controller housed in a lower compartment of the unit 300. It is connected to any device that allows the temperature, humidity and light on the plant side 311 to be varied, and the temperature and humidity on the root side 310 to be varied according to a control set-point. The regulation system 316 preferably operates in real time, based on the data from the measuring equipment 315.

For example, the lighting of the plant side 311 is achieved by a lighting device 322 for lighting the plant side 311 in the cultivation compartment 307. The lighting device 322 includes, for example, horizontal arms 323 attached to the frame 301. The arms 323 are attached, for example, between each side wall 302 and the intermediate wall 313. The arms 323 each support an arrangement of LEDs, not shown in the figures, the LEDs being placed facing the plate 309 of the growth medium 308, and distributed so as to light the stems and leaves of the plants hanging from the plate 309 in a uniform manner, on the side 311 of the plants. The regulation system 316 then acts on the intensity of the power supply to the LEDs to vary the light. The arms 323 can be articulated to the frame 301, for example by means of a ball-and-socket joint, to change their orientation and/or to move them away from the plate 309 of the growth medium 308 to facilitate access to the medium 308.

Also for example, the regulation system 316 is connected to a ventilation device in the cultivation compartment 307.

The regulation system 316 can also be provided to control the flow rate and pressure of the nutrient solution sprayed from the nozzles 314 into the root side 310.

A unit 300 can further include a nutrient solution control system 324. In particular, the control system 324 allows the proportions of the inputs, i.e. the formula, of the nutrient solution to be controlled, e.g. according to measurements by the measuring equipment 315, according to the plant species, according to a defined cycle or according to a manual adjustment. The control system 324 can be connected to the regulation system 316, so as to determine the proportions of the inputs according to, for example, the data from the measuring equipment 315.

In practice, as will be seen below, the regulation system 316 as well as the control system 324 can be shared by several units 300.

The units 300 are assembled in pairs to form racks 200.

More specifically, a rack 200 includes two rows 201 of units 300 facing each other. Each row 210 includes at least one, and in practice several, cultivation units 300 as described below. The units 300 in a row are connected to each other so that they can be moved together. For example, two adjacent units 300 are in contact with each other along one of their side walls 302, and can be fixed together. The units 300 in a row 201 are oriented in the same direction, i.e. their opening 306 is oriented in the same direction. According to one embodiment, the units 200 in a row 201 are substantially identical, so that their bottoms 305 can be in the same plane and, similarly, their openings 306 can be in the same plane.

Within a rack 200, the cultivation compartment 307 of a unit 300 of a first row is oriented opposite the cultivation compartment 307 of a unit 300 of a second row. In practice, each cultivation compartment 307 of the units in a first row faces a cultivation compartment 307 of the units 300 in the second row 201. In other words, the openings 306 of the units 300 of a first row 201 are oriented in the same and opposite direction to the openings 306 of the units 300 of the second row 201. The rack 200 further comprises a device 202 for moving the two rows 201 relative to each other so that the rack 200 can take on two configurations:

an open configuration, wherein the cultivation compartment 307 of each unit 300 of the first row 201 is separated from the cultivation compartment 307 of each unit 300 of the second row 201 by an open-air circulation corridor 203, the growth media being accessible from the circulation corridor 203;

a closed configuration, wherein the opening 306 of each unit 300 of the first row 201 is in communication with the opening 306 of at least one unit 300 of the second row 201, so that the cultivation compartments 307 are shared and form at least one cultivation chamber 204, the rack also including a sealing system 205 limiting the exchange of air between the cultivation chamber 204 of the rack in the closed configuration and the outside.

The size of the corridor 203 when the rack 200 is in the open configuration is adapted to allow the circulation of an operator, automatic or human, and to give this operator access to the cultivation compartments 307 of the units 300 of the rack 200. This allows the operator to harvest the plants on the growth medium 308 or to place new plants on the growth medium 308.

The sealing system 205 includes, for example, a device for pressurizing the cultivation chamber 204 in order to limit the entry and exit of air with the outside. The pressurisation device is for example connected to the regulation system 316 of a unit 300 which deactivates the pressurisation when the rack is in the open configuration.

Alternatively or in combination, the sealing system 205 can include a seal, made, for example, of elastomer, extending around the cultivation chamber 204, when the rack 200 is in the closed configuration. For example, the seal is formed by two half-seals 206, each half-seal 206 being attached to the units 300 of two rows 201 of the rack 200.

In the closed configuration, the rack 200 can define a single cultivation chamber 204 formed by all of the cultivation compartments 307 of the rack units 300. Alternatively, the rack includes several cultivation chambers 204. For example, the cultivation compartment 307 of a unit 300 of the first row defines, with the cultivation compartment 307 of a unit 300 of the second row, a cultivation chamber 204. In this case, the sealing device 205 can provide a seal between the cultivation chambers 204. Any intermediate arrangement between these two cases is clearly possible.

According to the embodiment of the figures, the cultivation chamber 204 is formed more precisely by sharing, on the plant side 311, the cultivation compartments 307 of the units of the two rows 201.

The measuring equipment 315 already described can then be shared by several units, especially for measurements in a cultivation chamber 204. Indeed, the closed configuration of a rack 204 is in principle the configuration that is implemented most of the time compared to the open configuration. The measuring equipment 315 can therefore monitor the characteristics of the atmosphere in the cultivation chamber(s) 204, and not in each cultivation compartment 307.

Similarly, the regulation system 316 can be shared by several units. Devices for modifying the characteristics of the atmosphere can also be shared by several units 300.

For example, the units 300 in a first row 201 of a rack 200 include measuring equipment 315, a regulation system 316, and a lighting device 322, and the units 300 in the second row do not.

According to one embodiment, the displacement device 202 allows the rows 201 of the rack 200 to be displaced in a sliding movement along a transverse, i.e. horizontal, direction substantially perpendicular to the plane of the opening 306 of the units 300, in order to move the two rows 200 away from each other in the open configuration.

The moving device 202 includes, for example, a rail system 207 and an actuator connected to the upper walls 303 of the units 300 to move the rows 201 along the rails.

Advantageously, the device 202 can be used to run any connection and/or power cables from a central computing device to each unit 300. All or part of the regulation system 316 can be integrated into the central computer unit, and a control command is then sent to each unit 300, either by cable or not.

Specifically, the rail system 207 can include at least one base including guide rails. The base is intended to be attached to a wall of, for example, a frame in which the rack 200 is intended to be installed. This is for example a vertical wall, a floor or a ceiling of the building. The units 300 in each row 201 then include a complementary member of the base rails.

The cultivation system 100 includes at least two racks 200, placed parallel to each other, each rack 200 being able to take on an open configuration and a closed configuration.

According to the embodiment of the figures, the cultivation units 300 of the cultivation system 100 are organised in modules 101, 102. The system (100) includes two types of modules:
A first type of module 101, known as an intermediate module, including two cultivation units 300 as described above, attached to each other by the bottom 305 of their frame 301. More specifically, the two units 300 of an intermediate module 101 have their frame 300 in common, their bottoms 305 being common. Their openings 306 are then oriented in two opposite directions. The side walls 302, top walls 303 and bottom walls 304 of the two units 300 of a module 101 are merged, in continuation of each other from the common bottom 305.
A second type of module 102, called an end module, including a unit 300 as described above.

The modules 101, 102 are placed in rows so as to form rows 201 for the racks 200.

Thus, according to the embodiment shown here, the cultivation system 100 includes successively a first row of end modules 102, at least one row of intermediate modules 101, and a second row of end modules 102.

In order to reduce manufacturing costs, the frames of the intermediate modules 101 are identical to the frames of the end modules 102, so that an end module includes, in addition to the cultivation compartment 307 of a cultivation unit 300, a secondary compartment 103.

The secondary compartment 103 can be used to house, for example, the central computer unit, which includes the regulation system 316, and/or the nutrient solution control system 324 for all the units 300 of the cultivation system 100.

According to one embodiment, the secondary compartment 103 of a first row of end modules 102 can be used to place 104 sprouting racks. Indeed, before placing the plants on the growth medium 308, they must have reached the stage of germination. This can be done in a less controlled environment than the rest of the cultivation. Thus, the secondary compartment 103 can be equipped for this purpose.

The secondary compartment 103 of the second row of end modules 102 can then be used to house the input tanks 105 and a pump system 106 connected to the nutrient solution delivery system to deliver the nutrient solution to the cultivation units 300 according to a formula determined by the control system 324. A cover 107 can be provided to close the secondary compartment 103 of each end module 102.

Each row of modules 101, 102 can include, on a side wall 302 of a module 101, 102 at the end of a row, a verification console 108, making it possible to monitor the characteristics of the atmosphere in the cultivation chambers 204, and/or on the root side 310 of the units 300, and/or to have a view of the interior of the units 300, in particular when the racks 200 are in the closed configuration. The console 108 can also include a control panel to allow an operator to directly control the atmosphere characteristics and/or nutrient solution supply if required.

Whenever an operator wishes to access a plant or plants, the operator identifies the relevant unit 300 and switches the rack 200 of the relevant unit 300 to the open configuration. Preferably, whenever the system 100 includes other racks 200, these then remain in the closed configuration. The operator can move along the circulation corridor 203 to reach the targeted plant(s), between two rows 201 of units 300.

An example of the implementation of the regulation system 316 of a unit 300 will now be described, it being understood that the regulation system 316 can be shared by several units 300, for example the units 300 of a row 201, of a rack 200, or even for all the units of the cultivation system 100.

According to this example, the regulation system 316 is connected to the sensors 317, 318, 319 on the plant side 311 and to the sensors 320, 321 on the root side 310 of the cultivation compartment 307 of the unit. The system 316 is also connected to the lighting device 322. The unit 300 can also include a ventilation device 325, connected to the regulation system 316

The regulation system 316 is further connected to the nutrient solution delivery system 326. The control system 324 includes, in this example, an input dispenser 327 containing the various inputs. The dispenser 327 is fluidly connected to a tank 328 with the nutrient solution. The inputs are mixed in the tank 328 from the dispenser 327, with the proportions of the inputs being controlled by, for example, the regulation system 316. The nutrient solution is then sprayed into the cultivation compartment 307, preferably on the root side 310 by means of a pump 329. Optionally, a filter 330 is interposed between the nutrient solution tank 328 and the pump 329 to avoid ensuring that only particles below a certain size reach the cultivation compartment 307. The pump 329 is associated with a booster 331 to ensure the spraying of the nutrient solution in the form of droplets of determined dimensions. For this purpose, the regulation system 316 is connected to a pressure sensor 332 and a flow controller 333 at the inlet to the cultivation compartment 307

The regulation system 316 can also be connected to a set of sensors 334 for monitoring the nutrient solution in the tank 328, for example temperature, pH, electro-conductivity and input composition of the solution.

The regulation system 316 then operates taking into account the information transmitted by the sensors 317, 318, 319, 320, 321 in the cultivation compartment 307 to adjust the characteristics of the atmosphere in the cultivation compartment 307, including the output of the ventilation device 325, the lighting device 322 or a temperature control device according to a predetermined control command.

The regulation system 316 can also control the composition of the nutrient solution, e.g. based on sensor data and/or a stored control cycle. To this end, the regulation system 316 regulates the dispenser 327 so that the composition of the nutrient solution in the tank 328 has the expected characteristics, based in particular on the information transmitted by the sensor system 334. The nutrient solution with the determined characteristics is then pumped and sprayed into the cultivation compartment 307. The regulation system 316, based on the data from the pressure sensor 322 and the status of the flow controller 33, is used to control the power of the pump 329.

Optionally, the cultivation compartment 307 can include a recovery device for excess nutrient solution, to be re-injected into the nutrient solution tank 328 after passing through a filter 335.

The regulation system 316 can be shared by several or all units of the cultivation system 100. For this purpose, each unit can be identified in the regulation system 316, and the control set-points can be adapted to each unit 300.

The cultivation system 100 including the cultivation units 300 thus enables controlled soil-less cultivation, adapting to the needs of the plants.

Indeed, arranging in units 300 makes it possible to create, for a rack 220, one or more cultivation chambers 204, each cultivation chamber 204 having its own characteristics, adapted in particular according to the species of plants.

The number of units 300 is easily adaptable by placing them side by side, increasing the number of units per row per rack 200 and/or increasing the number of racks.

The regulation system 316 provides increased control over the parameters of the soil-less cultivation, including the characteristics of the atmosphere in the cultivation chambers 204, but also the characteristics of the nutrient solution sprayed on the root side 310 of the units 300.

Access to the plants is easily achieved by switching to an open configuration for one rack 200, leaving any other racks closed and therefore without disturbing the atmosphere in the cultivation chamber(s) 204 of the other racks 200.

The vertical configuration of the plates 309 of the growth media 308 in particular allows the floor area occupied by the cultivation system 100 to be reduced.

1. A soil-less cultivation rack (200) including at least a first row (201) and a second row (201), each row (201) including at least one cultivation unit (300), each cultivation unit (300) including a frame (301) framing at least one cultivation compartment (307), the frame (301) of each unit having an opening (306) leading into the cultivation compartment (307), and closed by a bottom on the side opposite the opening and each unit (300) including at least one growth medium (308) in the cultivation compartment (307) attached to the frame (301), the growth medium (308) being intended to allow the hanging and development of at least one plant, the rack (200) including a system for distributing a nutrient solution in the cultivation compartment (307) of each unit (300), the rack also including a device (202) for moving the two rows (201) relative to each other so that the rack (200) can take on two configurations:
an open configuration, in which the cultivation compartment (307) of each unit (300) of the first row (201) is separated from the cultivation compartment (307) of each unit (300) of the second row (201) by an open-air circulation corridor (203), the growth mediums (308) being accessible from the circulation corridor (203);
a closed configuration, in which the opening (306) of each unit (300) of the first row (201) is in communication with the opening (306) of at least one unit (300) of the second row (201), so that the cultivation compartments (307) are shared and form at least one cultivation chamber (204), the rack (200) also including a sealing system (205) limiting the exchange of air between the cultivation chamber (204) of the rack (200) in the closed configuration and the outside.

2. A cultivation rack (200) according to claim 1, wherein the sealing system (205) comprises a device for pressurising the cultivation chamber (204).

3. A cultivation rack (200) according to claim 1 or claim 2, wherein the sealing system comprises at least one seal (206) extending around the cultivation chamber (204), when the rack (200) is in the closed configuration.

4. A cultivation rack (200) according to claim 1 or claim 2, wherein the two rows (201) are movable relative to each other by sliding in a transverse direction, and wherein the opening (306) of the frame (301) of each unit (300) extends parallel to a longitudinal plane.

5. A cultivation rack (200) according to claim 1 or claim 2, wherein each row (201) comprises at least two cultivation units (300), the frame (300) of each unit (301) including two side walls (302) connecting a top wall (303) and a bottom wall (304), the side walls (302), the upper wall (302) and the lower wall (304) enclosing the cultivation compartment (204), the two units (300) of the same row (201) being connected to each other by a side wall (302) the opening (306) of the frame (300) of the two units (300) of the same row (201) being oriented in the same direction so that the cultivation compartment (307) of a row (200) is accessible through the corridor (203) when the rack (200) is in the open configuration, the cultivation compartment (307) of each unit (300) of a first row (201) being in communication with the grow compartment (307) of a unit (300) of the second row (201) when the rack (200) is in the closed position.

6. A cultivation rack (200) according to claim 1 or claim 2, including equipment (315) for measuring at least one characteristic of the atmosphere of the cultivation chamber (204) and a system (316) for regulating said characteristic of the atmosphere in the cultivation chamber (204) of the rack (200) in the closed position.

7. A rack (200) according to the preceding claim, wherein the characteristic of the atmosphere comprises:
the temperature,
the humidity,
the brightness.

8. A rack (200) according to claim 1 or claim 2, including a nutrient solution delivery system (326).

9. A soil-less cultivation module (101) including at least two soil-less cultivation units (300) for plant cultivation particularly intended to be included in a cultivation rack (200) according to any of the preceding claims, each unit (300) including a frame (301) enclosing at least one cultivation compartment (307), the frame (301) of each unit (300) having an opening (306) leading into the cultivation compartment (307), and each unit (300) having a growth medium (308) in the cultivation compartment (307) attached to the frame (301), wherein the frame (301) of the two units (300) comprises a bottom (305) on the opposite side to the opening (306), the bottom (305) of the frames (301) of the two units (300) of the module (101) being shared.

10. A module (101) according to the preceding claim, wherein the growth medium (308) of each unit (300) comprises at least one inert plate (309) defining a so-called root side (310), in which the roots of the plant are intended to be placed, and a so-called plant side (311), in which the stems and/or leaves of the plant are intended to be placed, the unit (300) including an outlet (314) of the nutrient solution delivery system on the root side (310).

11. A module (101) according to the preceding claim, wherein the outlet (314) of the distribution system of each unit comprises at least one nozzle projecting droplets of the nutrient solution.

12. A module (101) according to any of the claims 9 to 11, wherein the plate (309) of the growth medium (308) of each unit extends parallel to the opening (306) of the frame.

13. A soil-less cultivation system (100) including at least two racks (200) according to any one of the claims 1 to 8, the rows (201) of the two racks (200) being placed substantially parallel to each other.

14. The soil-less cultivation system (100) according to the preceding claim, wherein the units (300) of a row (201) of a first rack (200) and the units (300) of a row (201) of a second rack (200) are assembled and form a row of modules (101) according to any according one of claims 9 to 12.
